(19) United States
(12) Patent Application Publication
(10) Pub. No.: US 2014/0368581 A1
(43) Pub. Date: Dec. 18, 2014

(54) LIQUID EJECTION HEAD SUBSTRATE AND LIQUID EJECTION HEAD

(71) Applicant: CANON KABUSHIKI KAISHA, Tokyo (JP)

(72) Inventors: Kenji Takahashi, Yokohama-shi (JP); Ichiro Saito, Yokohama-shi (JP); Maki Kato, Fuchu-shi (JP); Yuzuru Ishida, Yokohama-shi (JP); Norihiro Yoshinari, Kawasaki-shi (JP); Yoshinori Misumi, Tokyo (JP); Takahiro Matsui, Yokohama-shi (JP); Toshiyasu Sakai, Kawasaki-shi (JP)

(21) Appl. No.: 14/306,089

(22) Filed: Jun. 16, 2014

(30) Foreign Application Priority Data
Jun. 17, 2013 (JP) 2013-126984

(51) Int. Cl. B41J 2/14

(52) U.S. Cl. CPC B41J 2/14427
USPC 347/64

(57) ABSTRACT

A liquid ejection head substrate includes a substrate, an element disposed on the substrate that generates thermal energy used for ejecting liquid, and a protective layer disposed at least at a position corresponding to the element. The protective layer contains iridium and has a density in the range of 21.0 g/cm³ to 22.7 g/cm³.

### BACKGROUND OF THE INVENTION

1. Field of the Invention

The present invention relates to a liquid ejection head substrate used in a liquid ejection head that ejects liquid, and to the liquid ejection head.

2. Description of the Related Art

In an ink jet recording system using thermal energy, heating elements arranged in an ink jet recording head substrate (liquid ejection head substrate) generate thermal energy, and the thermal energy boils causes film boiling of ink (liquid). The ink is thus ejected onto a recording medium for recording. A thermally operating portion in direct contact with the ink is subjected to mechanical impact (cavitation) resulting from repeating generation and dissipation of bubbles. Also, the thermally operating portion is affected by thermal stress resulting from a large temperature change of several hundred degrees occurring for a very short time of several microseconds. Furthermore, the thermally operating portion undergoes chemical action of the ink because it is in contact with the ink.

In order to protect the heating elements from such impact or action, an ink jet recording head substrate is provided with a protective layer or protective film including a thermally operating portion corresponding to the thermal elements. A tantalum film of about 0.2 μm to 0.5 μm in thickness has been known as the protective layer. The tantalum film is relatively resistant to cavitation impact and chemical action of ink.

As high-speed, high-quality recording is demanded nowadays, the durability of the head is being considered to be important. In Japanese Patent Laid-Open No. 5-301345, such a protective layer is made of a platinum group element, such as iridium or platinum, which is more chemically stable and mechanically stronger than tantalum.

### SUMMARY OF THE INVENTION

A liquid ejection head substrate according to an embodiment of the present invention includes a substrate, an element disposed on the substrate that generates thermal energy used for ejecting liquid, and a protective layer disposed at least at a position corresponding to the element. The protective layer contains iridium, and has a density in the range of 21.0 g/cm³ to 22.7 g/cm³.

Further features of the present invention will become apparent from the following description of exemplary embodiments with reference to the attached drawings.

### BRIEF DESCRIPTION OF THE DRAWINGS

FIGS. 1A and 1B are perspective views of an ink jet recording apparatus and an ink jet recording head unit.

FIGS. 2A, 2B and 2C are a perspective view, a sectional view and a top view, respectively, of an ink jet recording head according to an embodiment of the invention.

FIG. 3 is a sectional view of an ink jet recording head according to a second example.

### DESCRIPTION OF THE EMBODIMENTS

The platinum group elements, such as iridium and platinum, used in Japanese Patent Laid-Open No. 5-301345 have higher thermal conductivities than tantalum. Accordingly, a protective layer made of such a material allows heat to escape to the surroundings, and the effective bubbling region of the heating elements involved with film boiling is reduced in area.

If the thickness of the protective layer is reduced to hinder heat from escaping, however, the mechanical strength decreases and a desired durability cannot be achieved. This may result in reduced life of the head.

Accordingly, the present invention provides a liquid ejection head substrate and a liquid ejection head, each including a protective layer that can exhibit satisfactory durability even though the thickness thereof is reduced to reduce the area of the effective bubbling region.

The liquid ejection head can be used in various types of apparatuses, such as printers, copy machines, facsimile machines including a communication system, and word processors including a printing portion, and, in addition, used in industrial recording apparatuses combined with processing devices. The liquid ejection head can print or record information on various types of recording media made of, for example, paper, threads or strings, fiber, cloth, leather, metal, plastics, glass, wood, and ceramics.

The term “recording” mentioned herein refers to forming, on a recording medium, not only images meaning something, such as letters or characters, figures, and diagrams, but also unmeaning images and graphics, such as patterns.

Also, the term “ink” mentioned herein should be understood in a broad sense, and refers to a liquid that can form images, figures, patterns or the like on a recording medium, work a recording medium, or treat another ink or a recording medium, by being applied to the recording medium. To treat an ink or a recording medium is an operation intended to increase the fixability of an ink applied onto a recording medium by solidifying or insolubilizing the coloring material in the ink, to increase recording quality or color developability, or to increase image durability.

Embodiments of the invention will now be described with reference to the drawings. In the following description, some parts having the same function are designated by the same reference numerals in the drawings, and thus description thereof is omitted.

### Ink Jet Recording Apparatus

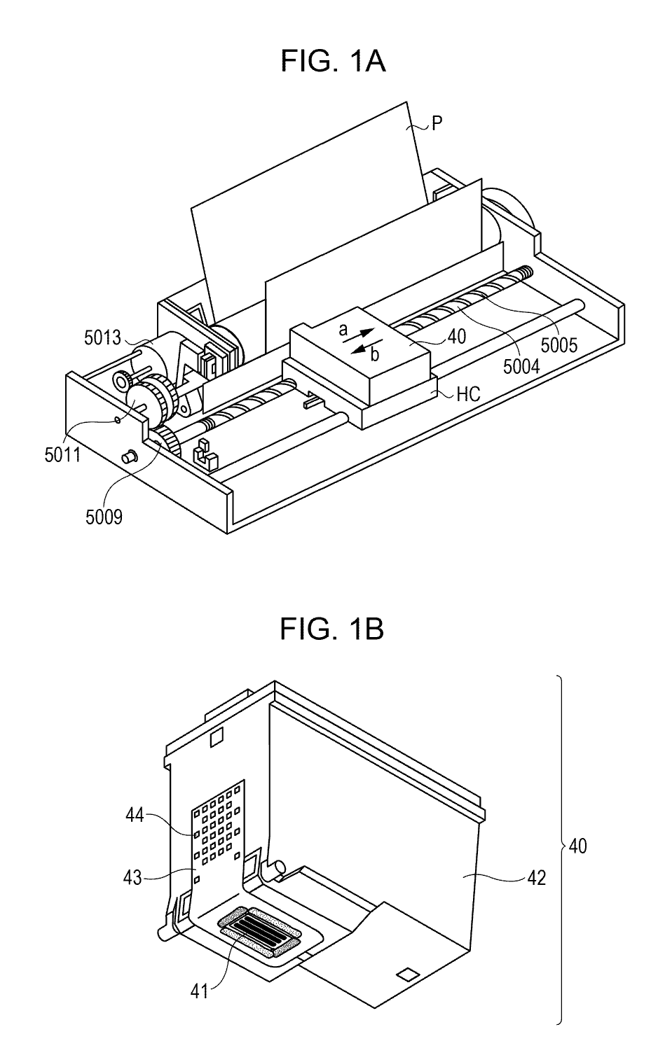

FIG. 1A is a schematic perspective view of an ink jet recording apparatus (liquid ejection apparatus). The ink jet recording apparatus includes a lead screw 5004 that rotates with driving force transmission gears 5011 and 5009 in conjunction with the positive and negative rotation of a driving motor 5013. The ink jet recording apparatus also includes a carriage HC having a pin (not shown) engaged in a helical groove 5005 of the lead screw 5004. The carriage HC is reciprocally moved in the directions indicated by arrows a and b by the rotation of the lead screw 5004. On the carriage HC, an ink jet recording head unit (head unit) 40 shown in FIG. 1B is mounded.

### Head Unit

FIG. 1B is a perspective view of a head unit 40 that can be used as the liquid ejection head unit mounted on the ink jet recording apparatus. The head unit 40 includes an ink jet recording head (head) 41 used as the liquid ejection head. The ink jet recording head 41 is electrically connected to contact pads 44 with a flexible film wiring substrate 43. The contact pads 44 are connected to the ink jet recording apparatus. Although the head 41 of the head unit 40 shown in FIG. 1B is integrated with an ink reservoir 42 in one body, the ink reservoir 42 may be separable.

### Ink Jet Recording Head

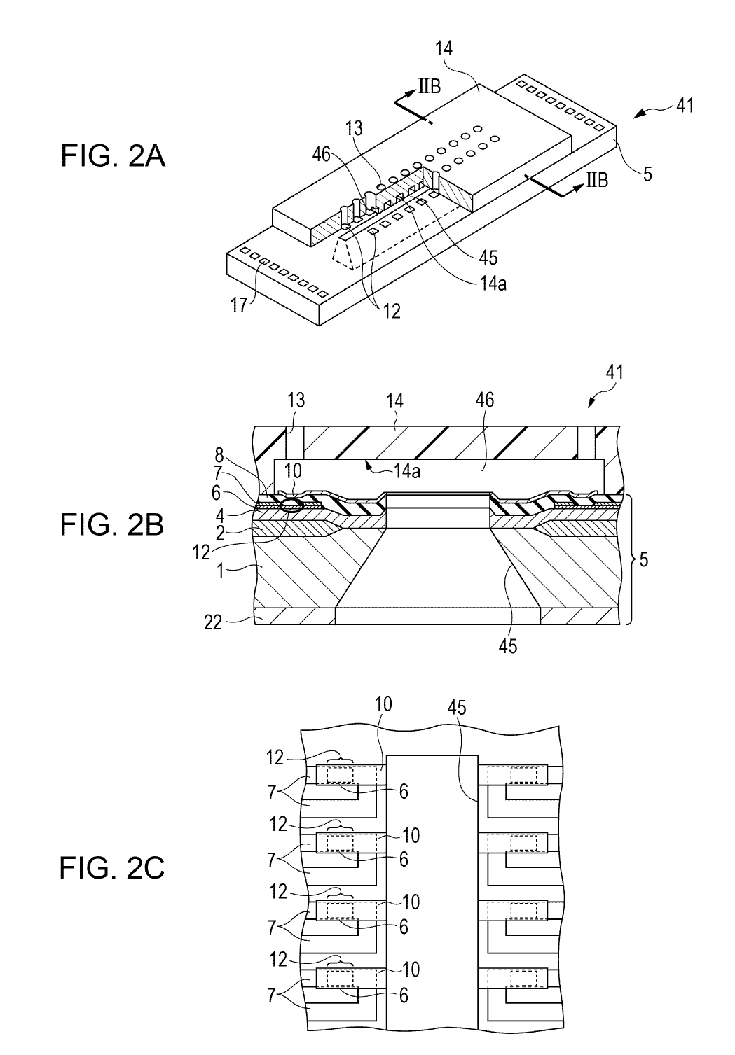

FIG. 2A is a perspective view of an ink jet recording head 41 according to an embodiment of the invention. FIG. 2B is a schematic sectional view of the ink jet recording head 41 taken along line IIB-IIB in FIG. 2A. FIG. 2C is a top view of an ink jet recording head substrate 5, illustrating energy generating elements 12 and their vicinity viewed from above, that is, viewed from a position closer to the energy generating elements 12 with respect to the substrate 1.

The ink jet recording head 41 includes the ink jet recording head substrate 5 used as the liquid ejection head substrate, and a flow channel wall member 14 disposed on the head substrate 5.

The head substrate 5 includes energy generating elements 12 that generate thermal energy used for ejecting ink. The head substrate 5 also includes a supply opening 45 through which ink is supplied, and terminals 17 used for external electrical connection to external devices or apparatuses, such as an ink jet recording apparatus.

The flow channel wall member 14 may be made of a cured thermosetting resin, such as epoxy resin, and has ejection openings 13 through which liquid is ejected, and walls 14a defining flow channels 46 communicating with the ejection openings 13. The flow channels 46 are defined by joining the flow channel wall member 14 to the head substrate 5 with the walls 14a facing inward. The ejection openings 13 in the flow channel wall member 14 are formed in a line with a predetermine pitch along the supply opening 45 in the head substrate 5.

The ink fed through the supply opening 45 is delivered to the flow channels 46, and is then film-boiled to bubble by thermal energy generated from each energy generating element 12. Thus generated bubbles enable the ink to discharge through the ejection openings 13, and thus recording is performed.

Referring to FIG. 2B, the substrate 1 is made of silicon and includes driving elements such as transistors, and on which a thermally oxidized layer 2 formed by thermal oxidation of part of the substrate 1, and a heat accumulation layer 4 made of a silicon compound are disposed. A heat generating resistive layer 6 made of a material capable of generating heat by electrification, such as TaSiN or WSiN, is disposed on the heat accumulation layer 4, and a pair of electrodes 7 mainly containing a material having a lower resistance than the heat generating resistive layer 6, such as aluminum, are in contact with the heat generating resistive layer 6. A voltage is applied to the pair of electrodes 7 through a terminal 17 to generate heat at the portion of the heat generating resistive layer 6 between the electrodes 7. This portion is thus used as the energy generating element 12. The heat generating resistive layer 6 and the pair of electrodes 7 are coated with an insulating layer 8 made of an insulating material such as SiN or any other silicon compound for electrical isolation from the ink. The order of the formation of the heat generating resistive layer 6 and the pair of electrodes 7 may be reversed.

The surface of the substrate 1 opposite the surface having the energy generating elements 12 has a thermally oxidized layer 22 thereon that has been used as a mask for forming the supply opening 45 by etching.

Furthermore, a protective layer 10 containing iridium as an anti-cavitation layer is disposed on the insulating layer 8, corresponding to the positions of the energy generating elements 12 for protecting the energy generating elements 12 from the impact of cavitation accompanying the generation and contraction of bubbles.

The protective layer 10 (protective films) is formed by dry-etching a deposited iridium film into portions corresponding to the energy generating elements 12.

An intermediate layer of, for example, tantalum may be provided between the protective layer 10 and the insulating layer 8 to increase the adhesion therebetween or help the crystal growth of the protective layer 10. The protective layer 10 may be covered with another protective layer made of, for example, tantalum. In other words, the energy generating elements 12 may be provided with a structure of protective layers thereover including a tantalum film and an iridium film, or a tantalum film, an iridium film, and a tantalum film, in that order from the element side.

Furthermore, an adhesion layer made of polyether amide or the like may be provided between the insulating layer 8 and the flow channel wall member 14 to increase the adhesion therebetween.

### First Example

Samples of the ink jet recording head 41 as described above were produced. The protective layer 10 of each sample was formed on a SiN insulating layer 8 by depositing iridium by DC magnetron sputtering under any of conditions (1) to (7) shown in Table 1. Under each deposition condition, iridium films were formed to different thicknesses 5 nm, 10 nm, 15 nm, 20 nm, 200 nm, and 500 nm. For this deposition, the time for forming an iridium film having a desired thickness was calculated from the deposition rate.

TABLE 1

| | Condition | | Condition | | Condition | | Condition | | Condition | | Condition | | Condition | |
|---|---|---|---|---|---|---|---|---|---|---|---|---|---|---|
| | (1) | | (2) | | (3) | | (4) | | (5) | | (6) | | (7) | |
| Substrate | 50° | C. | 100° | C. | 150° | C. | 200° | C. | 250° | C. | 250° | C. | 300° | C. |
| temperature | | | | | | | | | | | | | | |
| Deposition | 1.5 | Pa | 1.2 | Pa | 1.0 | Pa | 0.8 | Pa | 0.6 | Pa | 0.4 | Pa | 0.2 | Pa |
| pressure | | | | | | | | | | | | | | |
| DC power | 4.0 | W/cm² | 4.0 | W/cm² | 2.5 | W/cm² | 2.5 | W/cm² | 1.5 | W/cm² | 1.0 | W/cm² | 1.0 | W/cm² |
| density | | | | | | | | | | | | | | |

The resulting iridium films were observed through an electron microscope. The iridium film sample formed over a period of time corresponding to the thickness of 5 nm was not continuous, and crystals thereof were grown in an island manner. On the other hand, the samples formed over periods of time corresponding to a thickness of 10 nm or more were continuous. The continuous samples having thicknesses of 10 nm or more were analyzed for density by measuring X-ray reflectance. The results are shown in Table 2. Since monocrystalline iridium has a density of 22.7 g/cm³, the resulting iridium film does not exceed this value.

TABLE 2

| | | Condition | Condition | Condition | Condition | Condition | Condition | Condition |
|---|---|---|---|---|---|---|---|---|
| | | (1) | (2) | (3) | (4) | (5) | (6) | (7) |
| Ir | 10 nm to | 20.5 g/cm³ | 21.0 g/cm³ | 21.5 g/cm³ | 21.9 g/cm³ | 22.0 g/cm³ | 22.3 g/cm³ | 22.7 g/cm³ |
| thickness | 500 nm | | | | | | | |

Each of the iridium films was dry-etched into a protective layer 10. As a result, the iridium film of 500 nm in thickness peeled off. This is because the stress on this film was increased due to the large thickness, and consequently, the adhesion is reduced. Accordingly, samples including iridium films having thicknesses other than 500 nm were used for producing ink jet recording heads.

The ink jet recording heads thus produced were subjected to test for ejection durability. For the test, each ink jet recording head was charged with an ink BCI-7eM manufactured by Canon, and the ink was ejected by applying a pulsed voltage of 24 V with a pulse width of 0.8 μs to the heat generating resistive layer 6 in a cycle of 15 kHz. The results are shown in Table 3.

TABLE 3

| | | Condition | Condition | Condition | Condition | Condition | Condition | Condition |
|---|---|---|---|---|---|---|---|---|
| | | (1) | (2) | (3) | (4) | (5) | (6) | (7) |
| Ir | 5 nm | Bad | Bad | Bad | Bad | Bad | Bad | Bad |
| thickness | 10 nm to | Bad | Good | Good | Good | Excellent | Excellent | Excellent |
| | 200 nm | | | | | | | |

In Table 3, the sample that continued ejecting the ink even after 5.0×10⁹ pulses of voltage were applied are represented as excellent. The samples are represented as good which continued ejecting the ink after 4.0×10⁹ pulses of voltage were applied, but which failed to eject the ink before the number of pulses reached 5.0×10⁹. The samples are represented as bad which failed to eject the ink before the number of pulses reached 1.0×10⁹.

As shown in Table 3, the samples using the 5 nm thick iridium films formed under conditions (1) to (7) and the samples using the iridium films having thicknesses of 10 nm to 200 nm formed under condition (1) failed to eject the ink before 1.0×10⁹ pulses of voltage were applied. These samples were analyzed after the test. As a result, the insulating layer 8 and the heat generating resistive layer 6 had been broken by cavitation impact.

The samples using the iridium films having thicknesses of 10 nm to 200 nm formed under conditions (2) to (4) continued ejecting the ink even after 4.0×10⁹ pulses of voltage were applied, and did not exhibit degradation in recording quality. After that, however, these samples failed to eject the ink before the number of pulses reached 5.0×10⁹. As shown in Table 2, the iridium films of these samples had a density of 21.0 g/cm³ or more and less than 22.0 g/cm³. These samples were analyzed after the test. As a result, the protective layer 10, or iridium film, had been broken by cavitation impact, and furthermore, the underlying insulating layer 8 and heat generating resistive layer 6 had also been broken by cavitation impact.

The samples using the iridium films having thicknesses of 10 nm to 200 nm formed under conditions (5) to (7) continued ejecting the ink even after 5.0×10⁹ pulses of voltage were applied, and did not exhibit degradation in recording quality. As shown in Table 2, the iridium films of these samples had a density of 22.0 g/cm³ or more and 22.7 g/cm³ or less. These samples were analyzed after the test. As a result, the protective layer 10, or iridium film, was maintained without being broken.

The above-described test results teach that it is desirable that the iridium film of the protective layer 10 of the ink jet recording head have a density in the range of 21.0 g/cm³ to 22.7 g/cm³ in order to ensure a desired durability. The present example suggests that an iridium film of 10 nm to 200 nm in thickness having a density in the above range can be a satisfactorily durable protective layer 10 without depending on the thickness thereof. Therefore, by controlling the density of the iridium film in the above range, the protective layer 10 can exhibit satisfactory durability even if the thickness thereof is reduced to reduce the area of the effective bubbling region.

The test results also suggest that the density of the iridium film is preferably in the range of 22.0 g/cm³ to 22.7 g/cm³.

In addition, it has been found that the DC sputtering conditions for forming the protective layer 10 and the density of the resulting iridium film have the following relationship. As the deposition pressure is reduced, the density of the film increases. This is because as the deposition pressure is reduced, the mean free path of sputtering particles increases, and thus the loss of kinetic energy of the sputtering particles decreases. Thus, more energy can be used for crystal growth. More specifically, an advantageous deposition pressure may be 1.2 Pa or less.

As the temperature of the substrate is increased, the density of the iridium film increases. This is because sputtering particles that have reached the substrate can receive more thermal energy from the substrate for crystal growth. More specifically, an advantageous temperature of the substrate may be 100° C. or more. As DC power density is increased, the kinetic energy of sputtering particles increases, and accordingly, the density of the deposited film tends to increase. However, since the deposition rate increases with increasing DC power density, crystals of the deposited film may not grow sufficiently. This may result in a low density of the resulting film. Thus, DC power density and the density of a deposited film do not have a regular relationship. More specifically, an advantageous DC power density may be in the range of about 1.0 W/cm² to 4.0 W/cm².

### Second Example

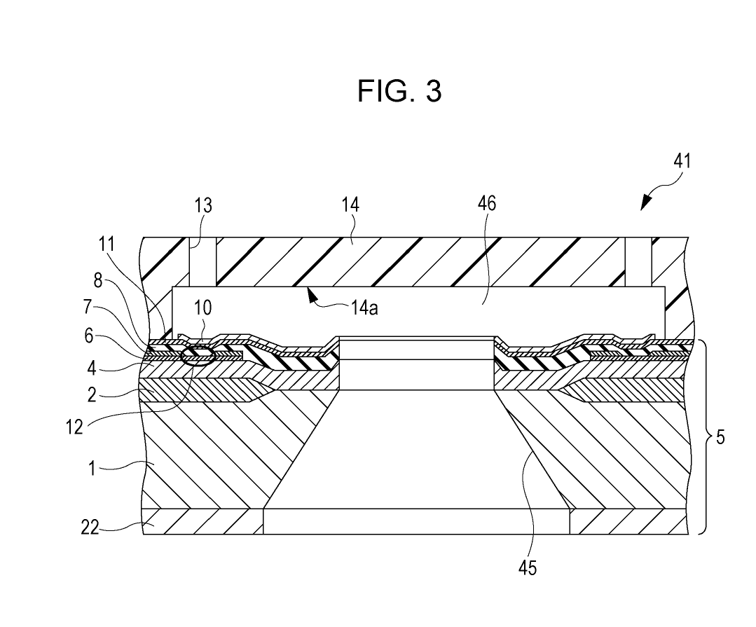

In the present example, a tantalum film 11 was provided between the SiN insulating layer 8 and the iridium protective layer 10, as shown in FIG. 3. Operations not specifically described were conducted in the same manner as in the first example.

A 50 nm thick tantalum film 11 was deposited on the SiN insulating layers 8 of the above-prepared substrates under the conditions: substrate temperature of 150° C., deposition pressure of 0.6 Pa, and DC power density of 1.4 W/cm². Subsequently, an iridium film was deposited by DC magnetron sputtering under the conditions shown in Table 1.

The resulting samples were subjected to X-ray diffraction analysis. The iridium film and the tantalum film 11 were oriented parallel to the (111) plane and the (001) plane, respectively, independently of the thickness of the iridium film. Accordingly, the lattice mismatch calculated from lattice spacings was 2.2%.

The iridium films of the samples were observed through an electron microscope, and it was confirmed that the films were continuous even though the thickness was as small as about 5 nm. This is because the tantalum film was crystalline and had a small lattice mismatch of 2.2% with the iridium film, thus allowing iridium to form a continuous film from the stage of a smaller thickness. Thus, a continuous iridium film with a smaller thickness than the iridium film of the first example can be formed as long as the lattice mismatch between the tantalum film and the iridium film (protective layer 10) is 2.2% or less. The iridium films were analyzed for density by measuring X-ray reflection, and the results are shown in Table 4.

TABLE 4

| | | Condition | Condition | Condition | Condition | Condition | Condition | Condition |
|---|---|---|---|---|---|---|---|---|
| | | (1) | (2) | (3) | (4) | (5) | (6) | (7) |
| Ir | 5 nm to | 20.5 g/cm³ | 21.0 g/cm³ | 21.5 g/cm³ | 21.9 g/cm³ | 22.0 g/cm³ | 22.3 g/cm³ | 22.7 g/cm³ |
| thickness | 500 nm | | | | | | | |

Each of the iridium films was dry-etched into a protective layer 10. As a result, the iridium film of 500 nm in thickness peeled off. This is because the stress on this film was increased due to the large thickness, and consequently, the adhesion is reduced. Accordingly, samples including iridium films having thicknesses other than 500 nm were used for producing ink jet recording heads.

The ink jet recording heads thus produced were subjected to test for ejection durability. For the test, each ink jet recording head was charged with an ink BCI-7eM manufactured by Canon, and the ink was ejected by applying a pulsed voltage of 24 V with a pulse width of 0.8 μs to the heat generating resistive layer 6 in a cycle of 15 kHz. The results are shown in Table 5. The criteria of the evaluation of which the results are shown in Table 5 were the same as those shown in Table 3.

TABLE 5

| | | Condition | Condition | Condition | Condition | Condition | Condition | Condition |
|---|---|---|---|---|---|---|---|---|
| | | (1) | (2) | (3) | (4) | (5) | (6) | (7) |
| Ir | 5 nm to | Bad | Good | Good | Good | Excellent | Excellent | Excellent |
| thickness | 200 nm | | | | | | | |

As shown in Table 5, the samples using the iridium films having thicknesses of 5 nm to 200 nm formed under condition (1) failed to eject the ink before 1.0×10⁹ pulses of voltage were applied. These samples were analyzed after the test. As a result, the insulating layer 8 and the heat generating resistive layer 6 had been broken by cavitation impact.

The samples using the iridium films having thicknesses of 5 nm to 200 nm formed under conditions (2) to (4) continued ejecting the ink even after 4.0×10⁹ pulses of voltage were applied, and did not exhibit degradation in recording quality. After that, however, these samples failed to eject the ink before the number of pulses reached 5.0×10⁹. These samples were analyzed after the test. As a result, the protective layer 10, or iridium film, had been broken by cavitation impact, and furthermore, the underlying insulating layer 8 and heat generating resistive layer 6 had also been broken by cavitation impact.

The samples using the iridium films having thicknesses of 5 nm to 200 nm formed under conditions (5) to (7) continued ejecting the ink even after 5.0×10⁹ pulses of voltage were applied, and did not exhibit degradation in recording quality. These samples were analyzed after the test. As a result, the protective layer 10, or iridium film, was maintained without being broken.

The above-described test results teach that it is desirable that the iridium film of the protective layer 10 of the ink jet recording head have a density in the range of 21.0 g/cm³ to 22.7 g/cm³ in order to ensure a desired durability. The present example suggests that an iridium film of 5 nm to 200 nm in thickness having a density in the above range can be a satisfactorily durable protective layer 10 without depending on the thickness thereof. Therefore, by controlling the density of the iridium film in the above range, the protective layer 10 can exhibit satisfactory durability even if the thickness thereof is reduced to reduce the area of the effective bubbling region.

The test results also suggest that the density of the iridium film is preferably in the range of 22.0 g/cm³ to 22.7 g/cm³.

Accordingly, an embodiment of the invention can provide a liquid ejection head substrate and a liquid ejection head, each including a protective layer that can exhibit satisfactory durability even though the thickness thereof is reduced to reduce the area of the effective bubbling region.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-126984, filed Jun. 17, 2013, which is hereby incorporated by reference herein in its entirety.

What is claimed is:

1. A liquid ejection head substrate comprising:
a substrate;
an element disposed on the substrate, configured to generate thermal energy used for ejecting liquid; and
a protective layer disposed at least at a position corresponding to the element, the protective layer containing iridium and having a density in the range of 21.0 g/cm³ to 22.7 g/cm³.

2. The liquid ejection head substrate according to claim 1, wherein the density of the protective layer is 22.0 g/cm³ or more.

3. The liquid ejection head substrate according to claim 1, wherein the protective layer has a thickness in the range of 10 nm to 200 nm.

4. The liquid ejection head substrate according to claim 1, further comprising:
an insulating layer overlying the element; and
a metal layer between the insulating layer and the protective layer, the metal layer having a lattice mismatch of 2.2% or less with the protective layer.

5. The liquid ejection head substrate according to claim 4, wherein the protective layer has a thickness in the rage of 5 nm to 200 nm.

6. The liquid ejection head substrate according to claim 4, wherein the metal layer contains tantalum.

7. A liquid ejection head comprising:
the liquid ejection head substrate as set forth in claim 1; and
a member defining a flow channel with the liquid ejection head substrate, the flow channel communicating with an ejection opening,
wherein the protective layer opposes the flow channel.
